(19) United States
(12) Patent Application Publication
(10) Pub. No.: US 2008/0247726 A1
(43) Pub. Date: Oct. 9, 2008

(54) VIDEO EDITOR AND METHOD OF EDITING VIDEOS

(75) Inventors: Kyung Ran Lee, Seoul (KR); Soon Ho Kwon, Seoul (KR); Joon-kee Chang, Yongin-si (KR); HoJin Jang, Seoul (KR); Dong Ho Park, Seoul (KR); Soon Sik So, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: NHN Corporation, Seongnam-si (KR)

(21) Appl. No.: 12/060,783

(22) Filed: Apr. 1, 2008

(30) Foreign Application Priority Data
Apr. 4, 2007 (KR) 10-2007-0033465

(51) Int. Cl. G11B 27/028

(52) U.S. Cl. 386/52

(57) ABSTRACT

Disclosed are a method and apparatus for processing and uploading a video file The method of processing the video file comprises: providing an image editor comprising an integrated user interface, which comprises a preview monitor and an editing board, wherein a plurality of thumbnail images of a plurality of videos are displayed on the editing board; displaying a selected one of the plurality of videos or a still frame of the selected video on the preview monitor in response to a user's selection of the video and the user's command for playing the selected video; and editing the selected video so as to provide an edited version of the selected video in response to the user's editing command while or after displaying the selected video on the preview monitor.

### CROSS-REFERENCE TO RELATED APPLICATION

This application claims priority from Korean Patent Application No. 10-2007-0033465, filed on Apr. 4, 2007, in the Korean Intellectual Property Office, the entire disclosure of which is incorporated herein by reference.

### BACKGROUND

1. Field

The present disclosure relates to technologies for editing videos.

2. Discussion of the Related Technology

Along with development in PCs, memories, and the like, an amount of data semi-permanently possessed by a user is increasing geometrically. Recent PCs constructing a variety of interfaces may facilitate to transmit/receive data to/from peripheral equipments, and also have a function for editing video data having been stored therein.

For example, conventional PCs may read video data embedded in a hard disk drive (HDD) or video data stored in a Universal Serial Bus (USB) peripheral device, edit the read video data into a new file useful to the user, and store the edited new file.

However, conventional editing schemes for editing a file in conventional PCs have problems in that a given file is merely edited and a plurality of files acquired by different encoding schemes are not allowed to be readily edited at one time, and in that a specific file is merely edited and stored, and the edited file is not allowed to be rapidly displayed to other users. In particular, the above described problems become more severe along with a trend of an increase in a number of users desiring to readily utilize an edited video image file in various fields.

### SUMMARY

One aspect of the prevent invention provides a method of processing a video. The method comprises: providing an image editor comprising an integrated user interface, which comprises a preview monitor and an editing board, wherein a plurality of thumbnail images of a plurality of videos are displayed on the editing board; displaying a selected one of the plurality of videos or a still frame of the selected video on the preview monitor in response to a user's selection of the video and the user's command for playing the selected video; and editing the selected video so as to provide an edited version of the selected video in response to the user's editing command while or after displaying the selected video on the preview monitor.

The integrated user interface may comprise a plurality of editing command buttons, each configured to generate an editing command. The plurality of videos to be edited may be displayed on the editing board in response to the user's selection. The selected video may further comprise at least one still image.

In the method, playing the selected video may comprise decoding of the selected video in a format playable by the image editor and may comprise encoding the edited version of the selected video into a desired format upon completion. The desired format may be a format required by a website, wherein the method may further comprise uploading the encoded format to the website. Upon completion of editing, uploading may upload the edited version to a website with or without the user's command to upload.

Still in the foregoing method, editing the selected video may comprise at least one selected video from the group consisting of cutting the selected video into two or more pieces of videos, combining two or more pieces of cut video pieces, inserting a desired image at a desired point of the selected video, and removing a portion of the selected video. The editing of the selected video may further comprise adding a transitional effect to the selected video and adding a special effect to the selected video, wherein the special effect comprises at least one from the group consisting of inserting text and inserting sound at a desired portion of the selected video. The editing may further comprise updating a thumbnail of the selected video on the editing board so as to indicate that the selected video has been edited.

Another aspect of the present invention provides an image editor. The image editor comprises: an integrated user interface comprising a preview monitor and an editing board, wherein the editing board comprising a space for displaying thumbnail images of videos; an image displaying module configure to display a selected video or a still frame thereof on the preview monitor in response to a user's selection of the video and the user's command for playing the selected video; and an editing module configured to edit the selected video in response to the user's editing command while or after the selected video is played on the preview monitor.

The integrated user interface of the image editor may further comprise a plurality of editing command buttons, each configured to generate an editing command. The plurality of editing command buttons may be configured to initiate an editing action selected from the group consisting of cutting the selected video into two or more pieces of videos, combining two or more pieces of cut video pieces, inserting a desired image at a desired point of the selected video, and removing a portion of the selected video, adding a transitional effect, inserting text, and inserting sound. The image editor may further comprise an editing module configured to update a thumbnail of the selected video on the editing board so as to indicate that the selected video has been edited.

The image editor may further comprise: a decoding module configured to decode a user's selected video in a format playable by the image editor; an encoding module configured to encode the edited version of the selected video in a desired format; and an uploading module configured to upload the edited version to a website without the user's command to upload.

Yet another aspect of the invention provides a computer executable program for processing a video. The program when executed may be configured to have a computer to perform a method that comprises: providing an image editor comprising an integrated user interface, which comprises a preview monitor and an editing board, wherein a plurality of thumbnail images of a plurality of videos are displayed on the editing board; displaying a selected one of the plurality of videos or a still frame of the selected video on the preview monitor in response to a user's selection of the video and the user's command for playing the selected video; and editing the selected video so as to provide an edited version of the selected video in response to the user's editing command while or after playing the selected video on the preview monitor.

### BRIEF DESCRIPTION OF THE DRAWINGS

The above and other aspects of the present invention will become apparent and more readily appreciated from the following detailed description of certain embodiments of the invention, taken in conjunction with the accompanying drawings of which:

FIG. 1 is a block diagram illustrating a configuration of an apparatus for editing and uploading an edited file according to an embodiment of the invention;

FIG. 2A is a diagram illustrating an example of a process where a method for editing and uploading an edited file according to an embodiment of the invention is initially performed;

FIG. 2B is a diagram illustrating another example of a process where a method for editing and uploading an edited file according to an embodiment of the invention is initially performed;

FIG. 3A is a diagram illustrating an example of a main screen provided by a method for editing and uploading an edited file according to an embodiment of the invention; FIG. 3B is a diagram illustrating another example of a main screen or user interface provided by a method for editing and uploading an edited file according to an embodiment of the invention;

FIG. 4 is a diagram illustrating a process where an arbitrary file intended to be edited is selected by a method for editing and uploading an edited file according to an embodiment of the invention;

FIG. 5 is a diagram illustrating a process where a selected file is partially edited by a method for editing and uploading an edited file according to an embodiment of the invention;

FIG. 6 is a diagram illustrating a process where an effect applying (general effect) function is added to an edited file by a method for editing and uploading an edited file according to an embodiment of the invention;

FIG. 7 is a diagram illustrating a process where a picture effect function is added to an edited file by a method for editing and uploading an edited file according to an embodiment of the invention;

FIGS. 8A and 8B are diagrams illustrating a process where a caption insertion function is added to an edited file by a method for editing and uploading an edited file according to an embodiment of the invention;

FIGS. 9A and 9B are diagrams illustrating a process where a title function is added to an edited file by a method for editing and uploading an edited file according to an embodiment of the invention;

FIGS. 10A and 10B are diagrams illustrating a process where an ending credit function is added to an edited file by a method for editing and uploading an edited file according to an embodiment of the invention;

FIGS. 11A and 11B are diagrams illustrating a process where a background sound effect function is added to an edited file by a method for editing and uploading an edited file according to an embodiment of the invention;

FIG. 12 is a diagram illustrating a process where a shot transition effect function is added to an edited file by a method for editing and uploading an edited file according to an embodiment of the invention;

FIG. 13A is a diagram illustrating a first step for uploading a new edited video file in a specific website by a method for editing and automatically uploading an edited file according to an embodiment of the invention;

FIG. 13B is a diagram illustrating a second step for uploading a new edited video file in a specific website by a method for editing and automatically uploading an edited file according to an embodiment of the invention;

FIG. 13C is a diagram illustrating a third step for uploading a new edited video file in a specific website by a method for editing and automatically uploading an edited file according to an embodiment of the invention; and

FIG. 14 is a flowchart illustrating a method for editing and uploading an edited file according to an embodiment of the invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

When detailed descriptions related to a well-known related function or configuration are determined to make the spirits of the present invention ambiguous, the detailed descriptions will be omitted herein. Also, terms used throughout the present specification are used to appropriately describe embodiments of the present invention, and thus may be different depending upon a user and an operator's intention, or practices of application fields of the present invention. Therefore, the terms must be defined based on descriptions made through the present invention.

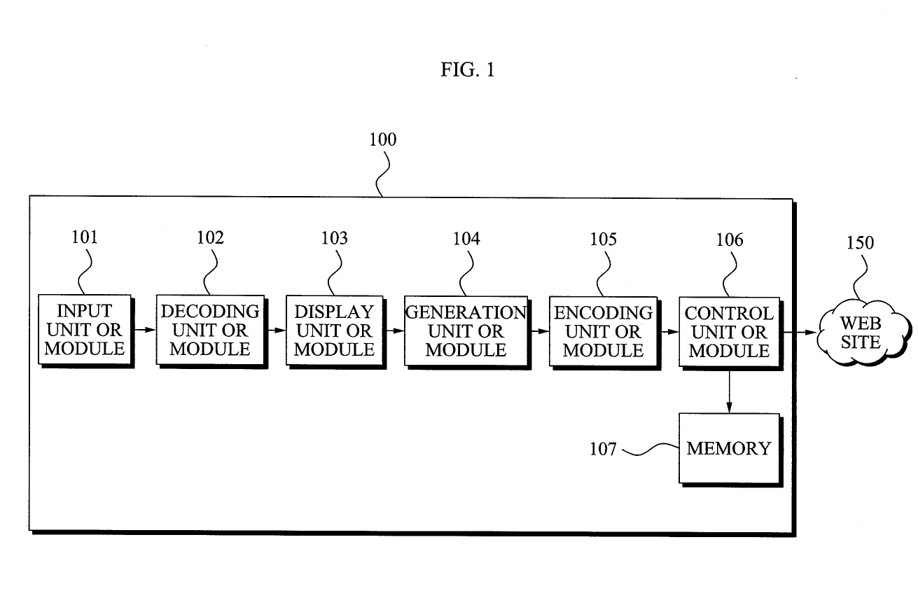

FIG. 1 is a block diagram illustrating a configuration of an apparatus 100 for editing and uploading an edited file according to an embodiment of the invention.

As illustrated in FIG. 1, the apparatus 100 for editing and uploading the edited file includes an input unit or module 101, a decoding unit 102, a display unit 103, a generation (editing) unit 104, an encoding unit 105, a control unit 106, and a memory 107. The apparatus 100 may designate a system which includes a memory means such as a Personal Computer (PC), a notebook PC, a Personal Digital Assistant (PDA), a mobile terminal, and the like and uses a microprocessor embedded therein to thereby have operation capabilities. Also, the apparatus 100 may communicate with a web site 150. Only configuration components directly or indirectly related with an embodiment of the present invention will be herein described in detail, and the description of other configuration components will be omitted. Despite this omission, however, the present invention will be well understood to those skilled in the art.

The input unit 101 may receive an authorization of a signal that selects at least one file intended to be edited. In this instance, the at least one file may be a moving image file, a still image file, a project file, and the like. The still image file may be a file photographed by a digital camera and the like. Unlike a conventional art, according to an embodiment of the present invention, the moving image file, the still image file, and the like may be simultaneously edited to be a single file. A demultiplexing unit (not shown) may extract video data and audio data from the video file, respectively.

The decoding unit 102 may decode the at least one file selected by the input unit 101. In particular, the decoding unit 102 may be designed to decode video data. The display unit 103 may display, within an identical region of a screen, a still frame image of each of the at least one file decoded by the decoding unit 102. The still frame image may be acquired by being decoded in a portion where the decoded file is initially started, or in an arbitrary region of the decoded file. According to an embodiment of the present invention, decoded results with respect to the at least one file may be simultaneously displayed in a predetermined region of a screen, thereby facilitating to edit the at least one file at one time by a user.

The generation or editing unit 104 may divide the at least one file into arbitrary parts based on the still frame image displayed by the display unit 103, and the divided arbitrary parts are connected with each other in an arbitrary order, thereby generating a new edited video file. A multiplexing unit (not shown) may add arbitrary audio data to the generated edited video file, and then multiplex the file. However, the arbitrary audio data may reuse the audio data extracted by the demultiplexing unit (not shown), or newly read audio data having been stored in a hard disk drive (HDD) and the like.

The encoding unit 105 may encode the edited video file into a format capable of being uploaded in the website 150 of an Internet server, or into a format capable of being stored in the memory 107. The memory 107 may have a configuration for storing data, file, and the like, and may be, for example, an HDD, flash memory, and the like. The control unit 106 may upload the encoded moving image edited file to the website 150 of the Internet server according to a predetermined criterion, or store the encoded edited video file in the memory 107. Accordingly, the video edited file may be rapidly uploaded to a specific website useful to the user without an additional operation performed by the user, thereby significantly rapidly performing the editing and uploading of the moving image file in comparison with the conventional art, and improving convenience of the user.

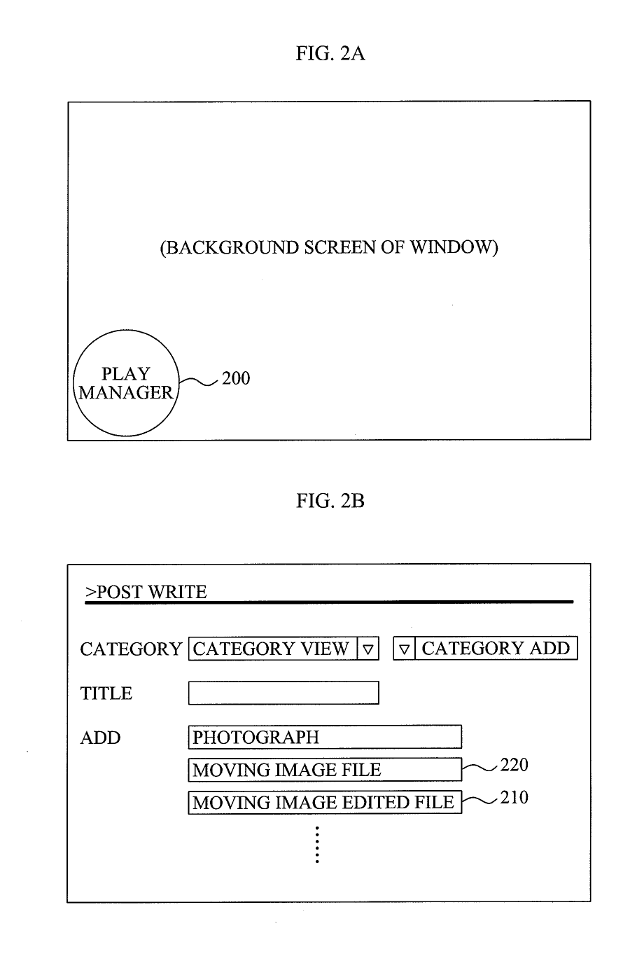

Hereinafter, series processes where the apparatus for editing and uploading the edited file is implemented will be sequentially described in detail with reference to FIGS. 2A to 13C.

FIG. 2A is a diagram illustrating an example of a process where a method for editing and uploading an edited file according to an embodiment of the invention is initially performed, and FIG. 2B is a diagram illustrating another example of a process where a method for editing and uploading an edited file according to an embodiment of the invention is initially performed. Hereinafter, a process where the method for editing and uploading the edited file according to an embodiment of the present invention is initially performed will be described in detail with reference to FIGS. 2A and 2B.

A function for implementing the method for editing and uploading the edited file of an embodiment of the present invention may be referred to as a ‘play manager’ function, however, an embodiment of the invention are not limited thereto.

A scheme for executing the play manager function initially is disclosed in an embodiment of the present invention and is described in the following two exemplary embodiments. First, as illustrated in FIG. 2A, an icon 200 of a play manager is shown on a desktop in Windows®, and the play manager is executed when the icon 200 is double-clicked. Second, as illustrated in FIG. 2B, items such as a video file 220 and an edited video file 210 may be provided on a screen for setting an attached file or setting a writing item in an arbitrary website. Here, when either the moving image file item 220 or the moving image edited file item 210 is clicked on, the play manager may be executed. In particular, the second exemplary embodiment may be a new technology and used on a website where various images are frequently uploaded, and thereby reduce inconvenience such that a user is required to search for and click on the play manager icon.

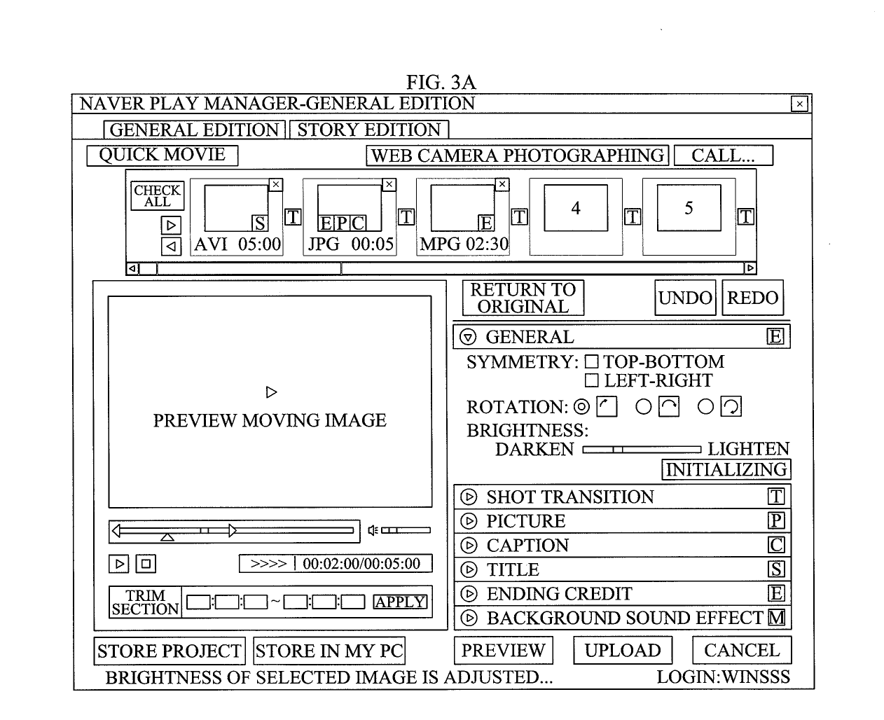

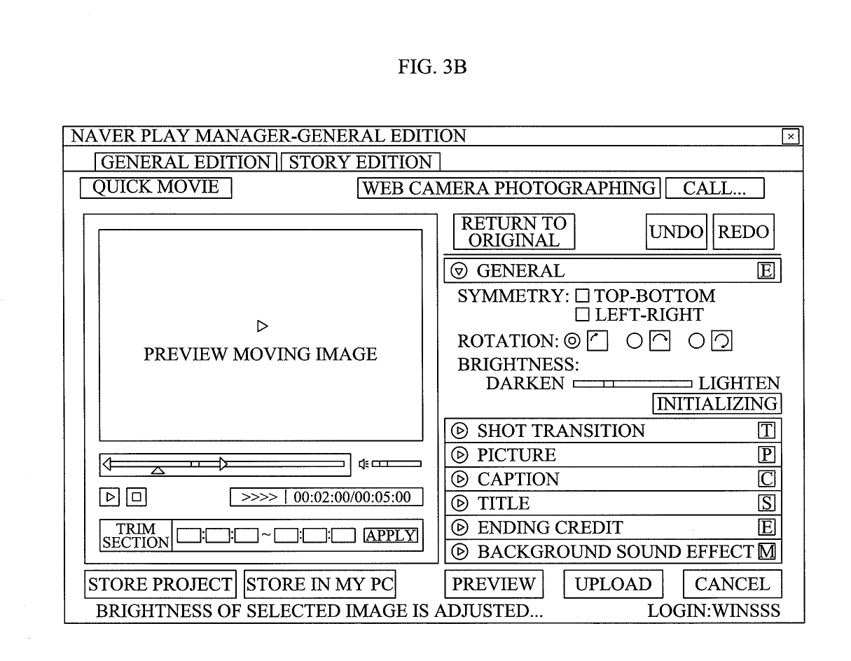

FIG. 3A is a diagram illustrating an example of a main screen provided by a method for editing and uploading an edited file according to an embodiment of the invention, and FIG. 3B is a diagram illustrating another example of a main screen provided by a method for editing and uploading an edited file according to an embodiment of the invention. Hereinafter, the main screen or user interface provided by the method for editing and uploading the edited file in an embodiment of the present invention will be described in detail with reference to FIGS. 3A and 3B.

When the play manager function of the invention is executed, the main screen as illustrated in FIG. 3A is initially displayed. As illustrated in FIG. 3A, the play manager function of the invention may include general edition/story edition menus. Here, the general edition may denote a case where an edition function with respect to a single file is executed, and the story edition may denote a case where an edition function with respect to at least two files is executed. In particular, when the story edition menu is selected, a large number of files may be readily edited at one time using a story board region and the like. However, the story board region may be a concept initially disclosed in the present invention, and denote a region where thumbnail images with respect to a plurality files intended to be edited are simultaneously displayed, as illustrated in FIG. 3A. The thumbnail image may serve as a representative image of respective files, and designate a video image of a front most portion where the file is decoded and displayed or a video image of an arbitrary portion where the file is decoded and displayed.

A call menu may be used for calling a still image file, a moving image file, a project file, and the like. Here, the still image file may be a file photographed by a digital camera and the like. The story board region as described above may be used for displaying clips (still image file, moving image file, and the like) called by the call menu in a thumbnail style. A preview monitor menu may be used for previewing an edited state. A playback control menu may be used for controlling a preview state of a clip currently played, and trimming and connecting edited sections.

The story board region may be a region where an edited state currently edited is sequentially shown, and displayed in the thumbnail style. A special effect icon menu may show an effect processing status with respect to clips such as general effect, picture effect, caption, and the like, and provide information used for re-editing the effect processing status. The special effect icon menu may also display, in a predetermined region, information indicating what special effect is inserted in each edited section, so that a user can readily apply a special effect to a large number of files and parts of the files, respectively. A shot transition icon menu may be a region indicating whether a special effect specifically applied to a connection portion between clips is used.

In particular, according to an embodiment of the present invention, the story board region for simultaneously displaying thumbnail images of all files intended to be edited, and a preview monitor region where a specific file intended to be edited is played may be simultaneously displayed unlike the conventional art. Here, a single file or at least two files may be read and divided into several files to thereby be displayed. Specifically, the story board region may function as an edition board and simultaneously display all files intended to be edited within a signal region, so that a plurality of files intended to be edited are frequently read and readily edited, and also a more convenient user interface is provided to the user. However, although the designations of the story board region and the preview monitor region may be used throughout the present specification, the designations are merely used as an example, and an original file and a currently edited file may be separately displayed a first region and a second region, respectively, without departing from the scope and the spirit of the present invention.

An effect menu may be used for selecting various special effects (e.g., effect applying, picture effect, caption insertion, title, ending credit, background sound, and the like). A capacity menu currently executed may be used for previewing a size of various files currently registered in the story board region, or indicating an executed status. A login menu may be used for providing an edited video file to a specific website. In the case where a log-in request is registered, when an edition is completed, the edited video file may be uploaded to the specific website requiring the log-in. For example, when the play manager according to an embodiment of the present invention is executed and the log-in request is registered using the login menu, the edited video file may be editing and uploaded to the website even without separately opening a specific website by the user. Obviously, an address of the website may be changed by the user.

As described above, the story edition function is described in FIG. 3A, and the general edition function is described in FIG. 3B. Here, the general edition function may be used for a case where a number of files intended to be edited is one.

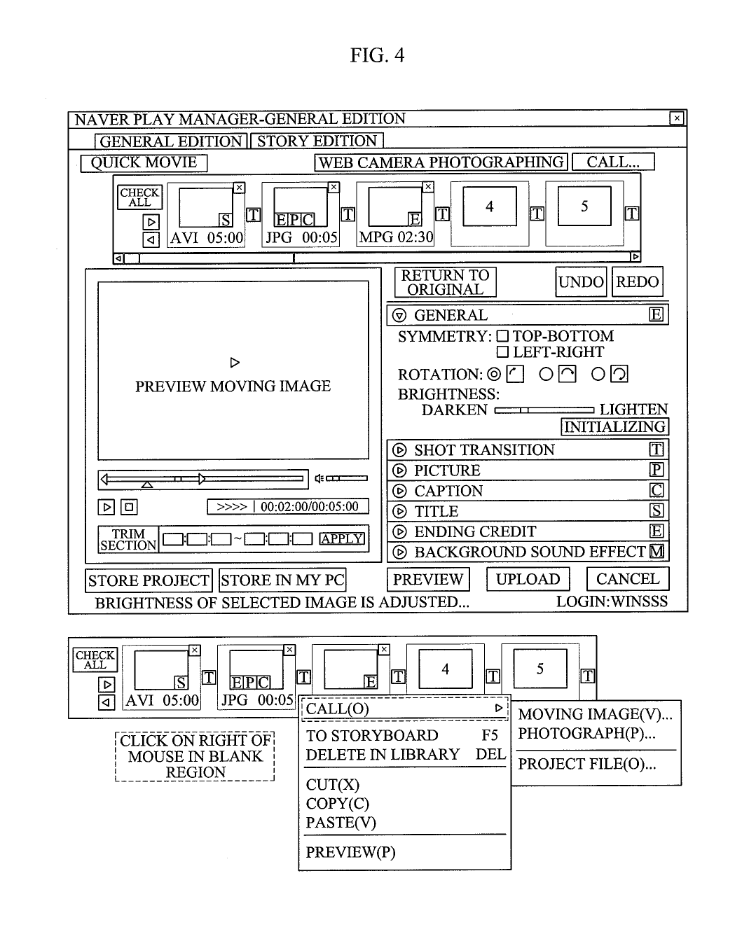

FIG. 4 is a diagram illustrating a process where an arbitrary file intended to be edited is selected by a method for editing and uploading an edited file according to an embodiment of the invention.

As illustrated in FIG. 4, the arbitrary file may be called using a call menu, or called by clicking on a right portion of a mouse in a black region of the story board region.

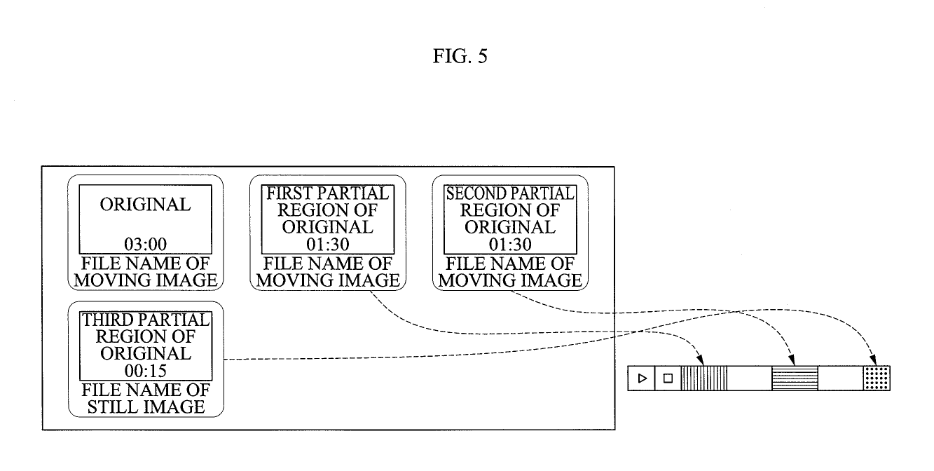

FIG. 5 is a diagram illustrating a process where a selected file is partially edited by a method for editing and uploading an edited file according to an embodiment of the invention.

As illustrated in FIG. 5, in the method for editing and uploading an edited file according to an embodiment of the invention, an arbitrary original file may be divided into three files and the divided three files may be edited. Also, even when the original file is a moving image file, the divided and edited files may include a moving image file and a still image file. Also, the original file may be trimmed in such a manner as to be partially duplicated to thereby generate an edited file which exceeds a playing time of the original file. Although a single original file is illustrated in FIG. 5, the present invention is not limited thereto. According to an embodiment of the present invention, at least two original files may be simultaneously edited, and therefore a problem of the conventional art occurring due to an inefficient process where a new file is required to be read and edited every time after an arbitrary file is read and edited may be solved.

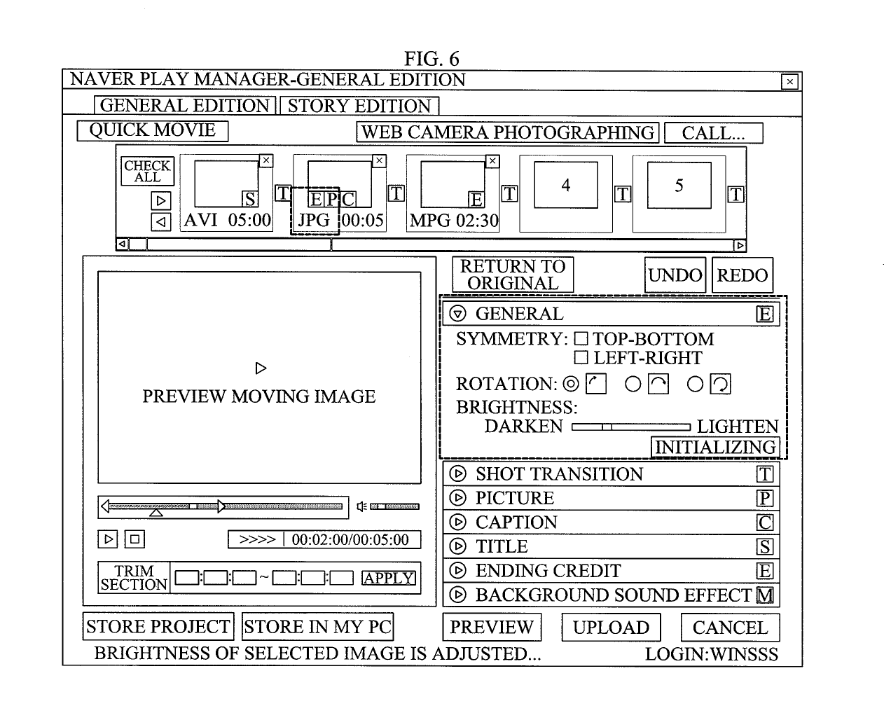

FIG. 6 is a diagram illustrating a process where an effect applying (general effect) function is added to an edited file by a method for editing and uploading an edited file according to an embodiment of the invention.

As illustrated in FIG. 6, it is assumed that a specific file is selected in the story board region and an effect applying menu is selected from the effect menu. Next, when a specific option is selected from the effect applying menu and an apply button is clicked on, video data with the added effect may be displayed in a specific region of the story board region and in the preview monitor menu.

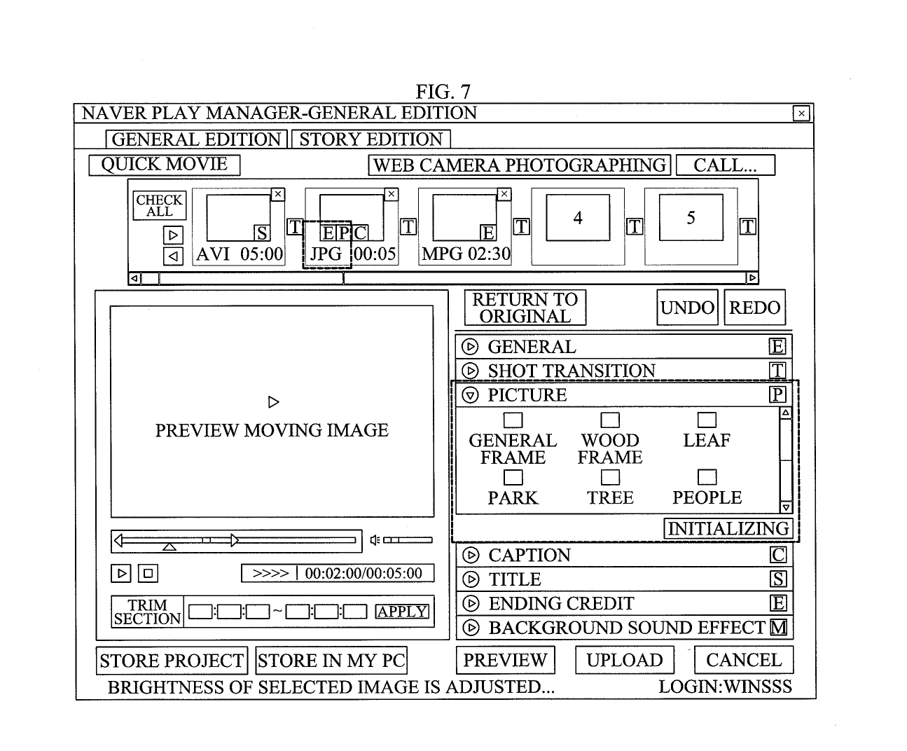

FIG. 7 is a diagram illustrating a process where a picture effect function is added to an edited file by a method for editing and uploading an edited file according to an embodiment of the invention.

As illustrated in FIG. 7, it is assumed that a specific file is selected in the story board region, and a picture effect menu is selected from the effect menu. Next, when a general frame option is selected from the picture effect menu and the apply button is clicked on, an effect icon of ‘T’ may be displayed in a specific portion of a specific file of the story board region. As a result, a user may readily check the applied special effect without replaying the edited file. Also, video data with the applied effect may be displayed in the preview monitor menu.

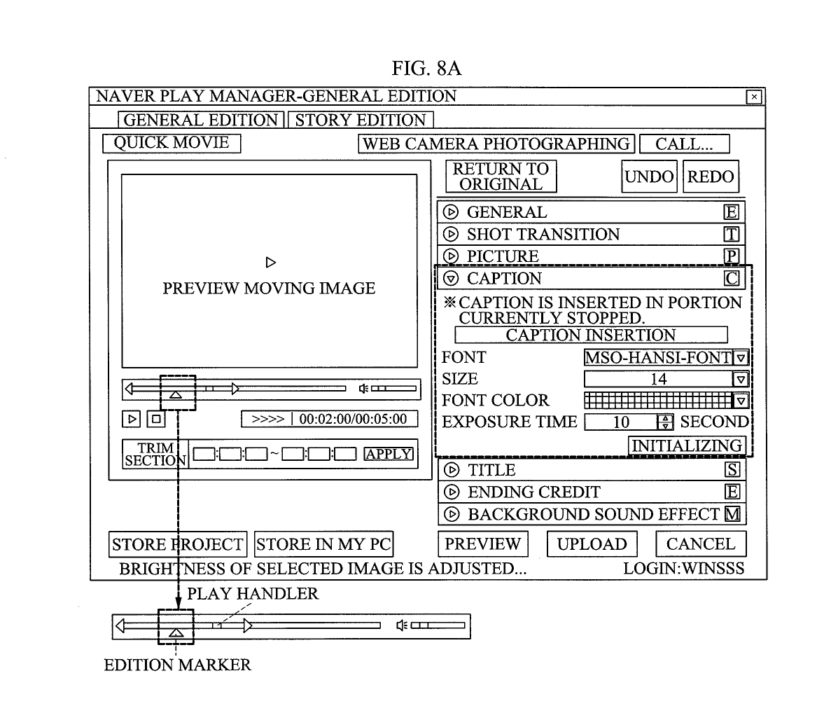

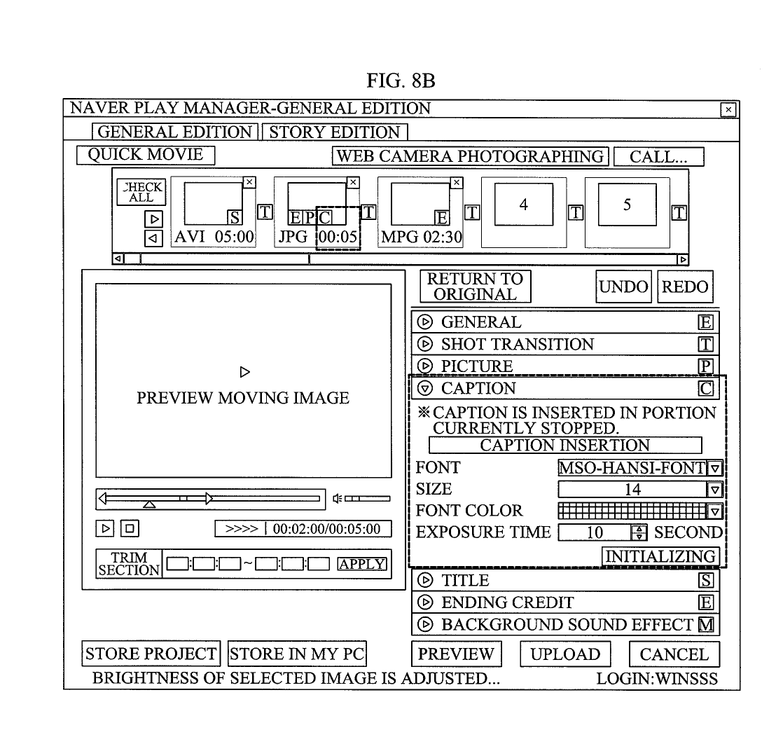

FIGS. 8A and 8B are diagrams illustrating a process where a caption insertion function is added to an edited file by a method for editing and uploading an edited file according to an embodiment of the invention.

As illustrated in FIGS. 8A and 8B, it is assumed that a specific file is selected in the story board region, and a caption insertion menu is selected from the effect menu. Next, when an arbitrary text is inputted in a specific region and the apply button is clicked, an effect icon of ‘C’ may be displayed in a specific region of the story board region. As a result, the user may readily check the applied special effect without replaying the edited file. Also, video data displaying the inputted text serving as a caption may be displayed in the preview monitor menu. Also, when a separate setting of a position of the caption is not performed, the caption may be displayed in a front portion of the edited video as a default, or may be displayed in an arbitrary position thereof, as illustrated in FIGS. 8A and 8B.

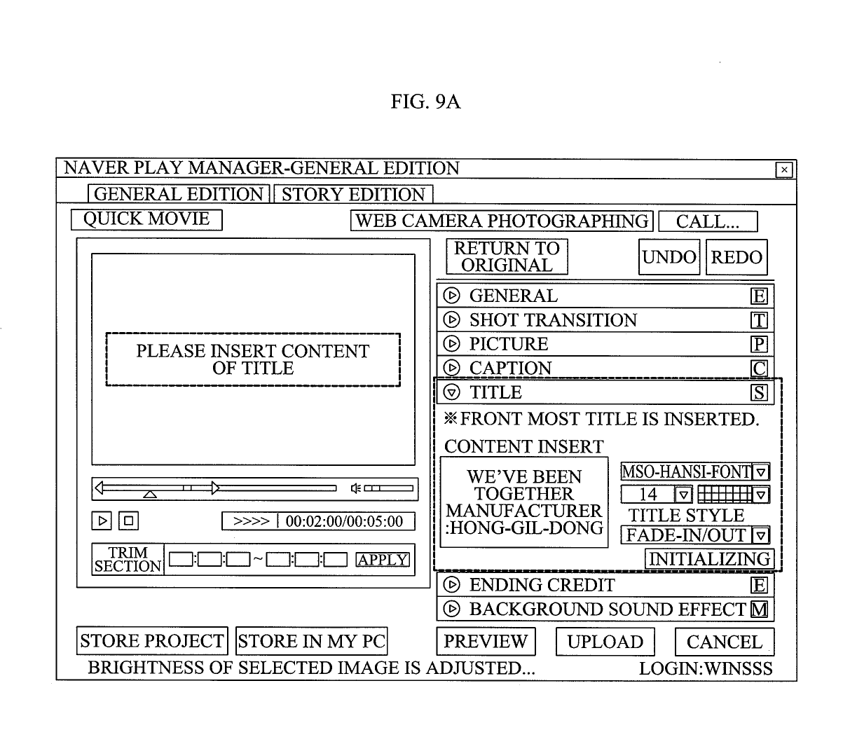

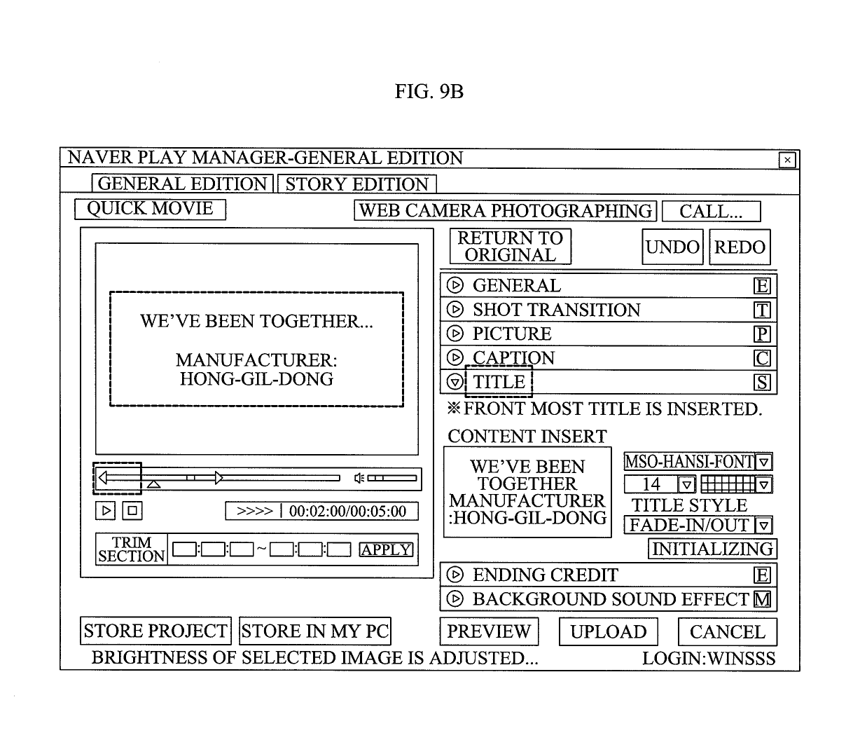

FIGS. 9A and 9B are diagrams illustrating a process where a title function is added to an edited file by a method for editing and uploading an edited file according to an embodiment of the invention.

As illustrated in FIGS. 9A and 9B, it is assumed that a title menu is selected from the effect menu. Next, when an arbitrary text is inputted in a specific region and the apply button is clicked on, the inputted text may be displayed as a title in the front most portion of the menu currently executed and in the preview monitor menu.

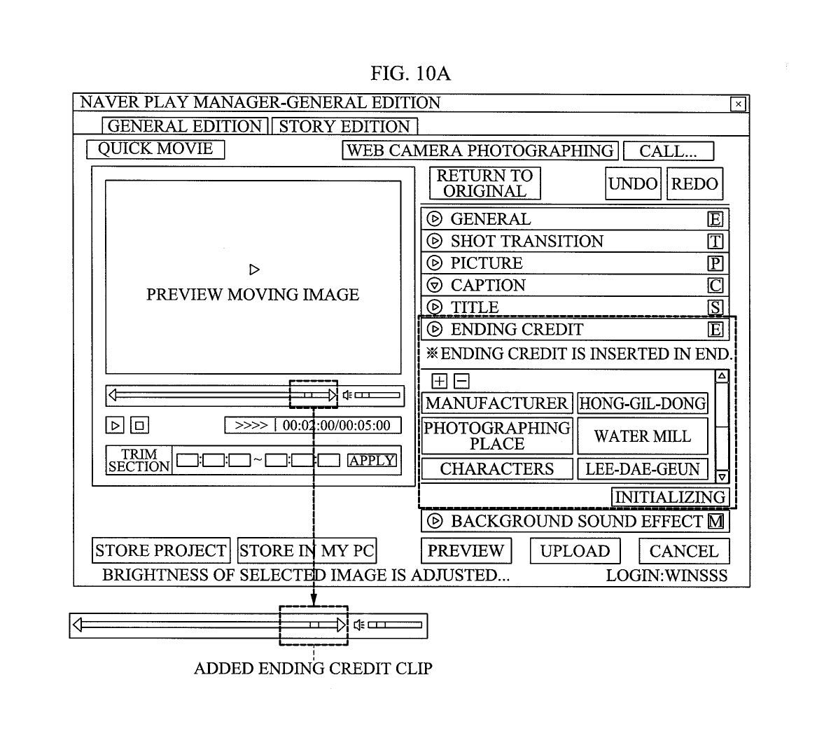

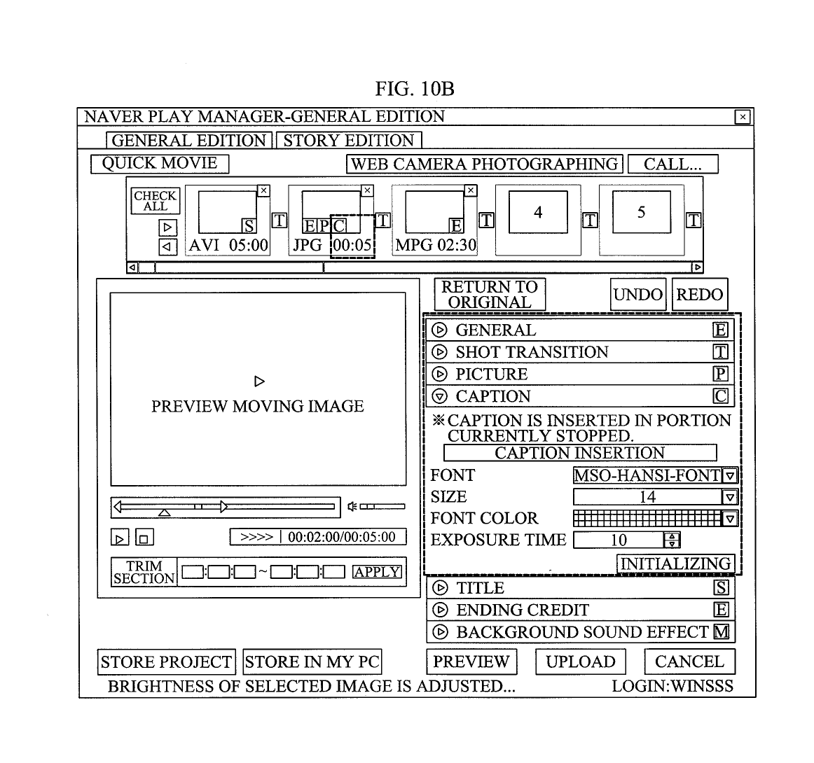

FIGS. 10A and 10B are diagrams illustrating a process where an ending credit function is added to an edited file by a method for editing and uploading an edited file according to an embodiment of the invention.

As illustrated in FIGS. 10A and 10B, it is assumed that an ending credit menu is selected from the effect menu. Next, when an arbitrary text is inputted in a specific region and the apply button is clicked on, the inputted text may be displayed as an ending credit in the rear most portion of the story board region and in the preview monitor menu.

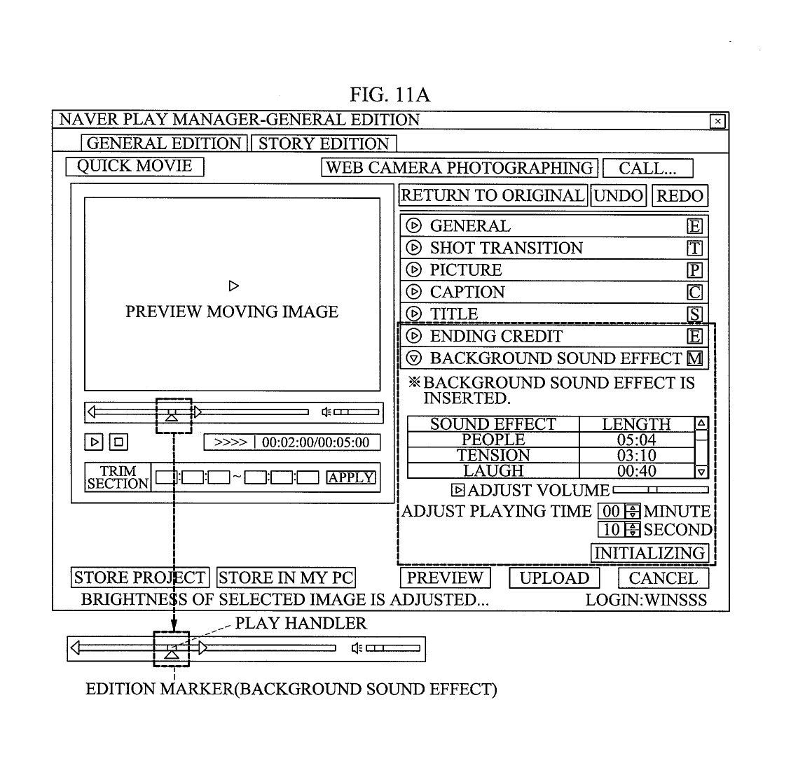

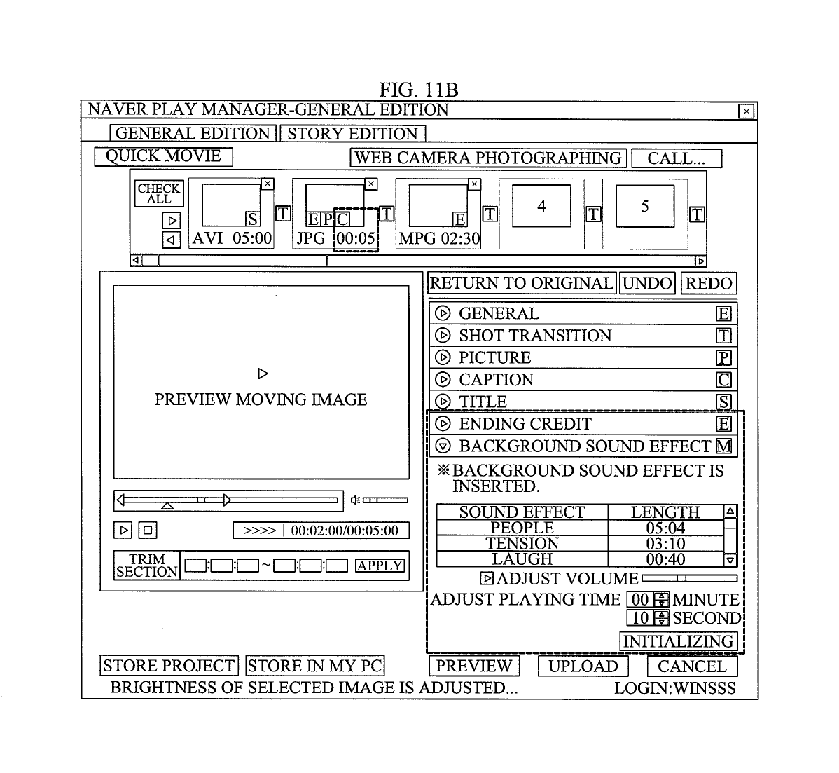

FIGS. 11A and 11B are diagrams illustrating a process where a background sound effect function is added to an edited file by a method for editing and uploading an edited file according to an embodiment of the invention.

As illustrated in FIGS. 11A and 11B, it is assumed that a background sound menu is selected from the effect menu. Next, when a specific sound/music file is selected using a file search region and the apply button is clicked on, the specific sound/music file may be outputted while the edited moving image file is being replayed. Further, although not shown, the edited moving image file may be divided into arbitrary parts and thereby different sound/music files may be replayed within the divided arbitrary parts.

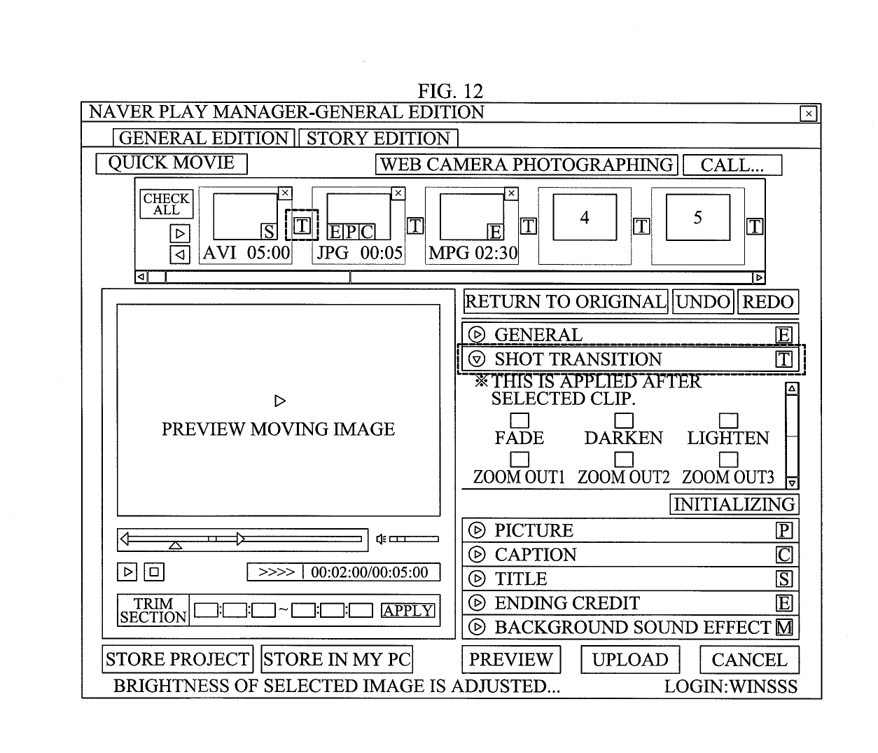

FIG. 12 is a diagram illustrating a process where a shot transition effect function is added to an edited file by a method for editing and uploading an edited file according to an embodiment of the invention.

As illustrated in FIG. 12, it is assumed that a connection portion between at least two files (clips) is selected, and then a transition menu is selected. Next, when a fade option is selected from the transition menu and the apply button is clicked on, video data with the applied effect may be displayed in the preview monitor menu.

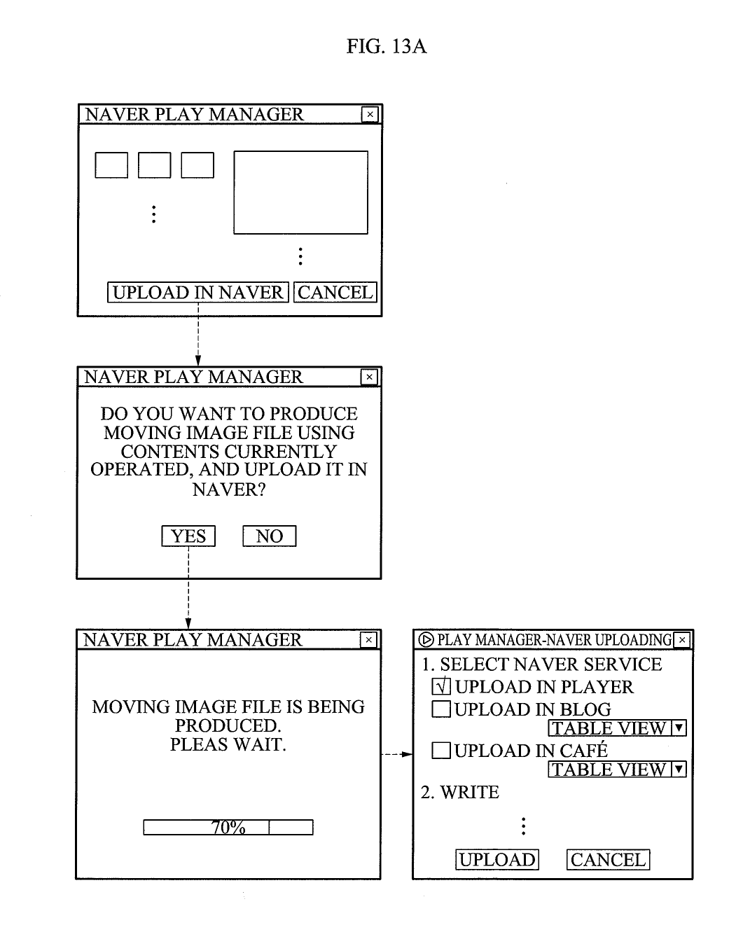

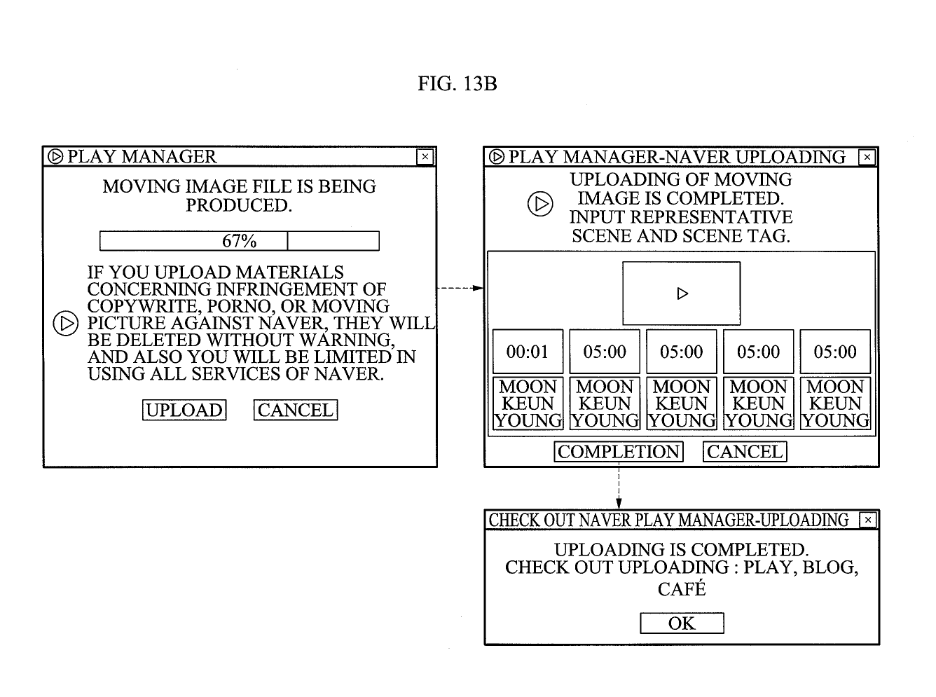

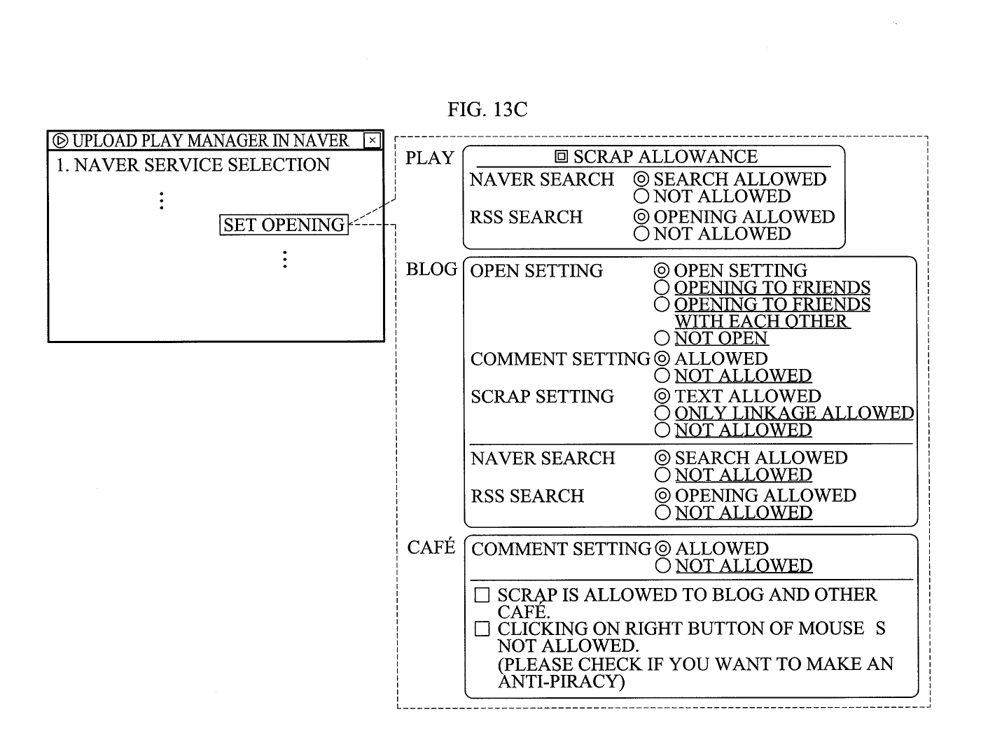

FIG. 13A is a diagram illustrating a first step for uploading a new edited video file in a specific website by a method for editing and automatically uploading an edited file according to an embodiment of the invention, FIG. 13B is a diagram illustrating a second step for automatically uploading an edited video file in a specific website by the method according to an embodiment of the invention, FIG. 13C is a diagram illustrating a third step for automatically uploading an edited video file in a specific website by the method according to an embodiment of the invention. Hereinafter, a process where a new moving image edited file is uploaded to a specific website by the method according to an embodiment of the present invention with reference to FIGS. 13A and 13B.

First, as illustrated in FIG. 13A, when a video file editing process as described in FIGS. 2A to 12 is completed, a guiding screen for checking whether to upload the moving image edited file to a specific website may be automatically generated. Also, it may be allowed that a user determines whether the edited file is uploaded to a specific blog, café, and the like having a predetermined website address. Also, it may be allowed that once the user sets the first step illustrated in FIG. 13A in advance, the edited video file may be always uploaded to a specific website when the file editing process is completed. Also, a website address where the user frequently uploads files via the Internet is searched for and stored in advance, and when the user does not execute a specific operation, the edited video file may be automatically uploaded to the stored website address.

As illustrated in FIG. 13B, the uploaded video file may be reviewed on the Internet, and as illustrated in FIG. 13C, an opening setting of the edited file may be separately determined. However, the open setting of the edited file may be determined by the user every time the video editing is completed, or once the user determines the opening setting in advance, an identical opening setting may be determined, thereby satisfying various needs of users, and improving convenience of users.

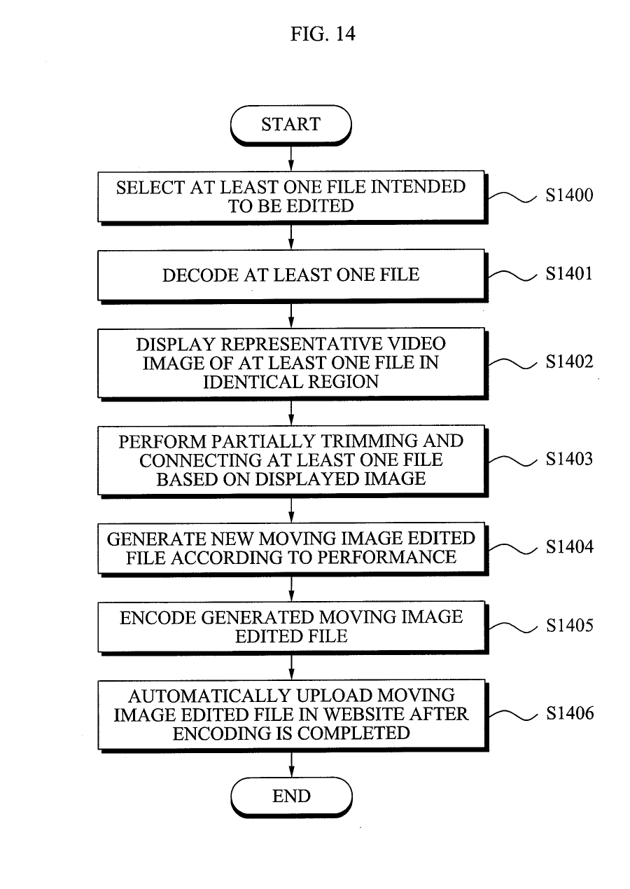

FIG. 14 is a flowchart illustrating a method for editing and uploading an video file according to an embodiment of the invention. FIG. 14 shows a sequential description of the above FIGS. 1 to 13C, and thus detailed descriptions thereof will be omitted.

In operation S1400, the play manager according to exemplary embodiments of the present invention selects at least one file intended to be edited when a specific signal is transmitted. In operation S1401, the play manager decodes the at least one file. In operation S1402, the play manager displays, within an identical region of a screen, a video image of the at least one file. In operation S1403, the play manager performs a partially trimming and connecting of the at least one file based on the displayed screen. In operation S1404, the play manager generates a new edited video file according to the above performance. In operation S1405, the play manager encodes the edited file. In operation S1406, the play manager automatically uploads the edited video file in a website after the encoding is completed.

The method for editing and uploading the edited file according to the above-described an embodiment of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software s in order to perform the operations of the above-described an embodiment of the present invention.

As described above, according to an embodiment of the present invention, a plurality of files of various types may be displayed on a single screen, and files to which a special effect is applied are separately shown, thereby allowing the files to be readily edited into a video file useful to the user.

According to exemplary embodiments of the present invention, a file edited into a style useful to the user may be rapidly uploaded to a specific website.

Although a few exemplary embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of processing a video, comprising:
providing an image editor comprising an integrated user interface, which comprises a preview monitor and an editing board, wherein a plurality of thumbnail images of a plurality of videos are displayed on the editing board;
displaying a selected one of the plurality of videos or a still frame of the selected video on the preview monitor in response to a user's selection of the video and the user's command for playing the selected video; and
editing the selected video so as to provide an edited version of the selected video in response to the user's editing command while or after displaying the selected video on the preview monitor.

2. The method of claim 1, wherein the plurality of videos are displayed on the editing board in response to the user's selection.

3. The method of claim 1, wherein playing the selected video comprises decoding of the selected video in a format playable by the image editor.

4. The method of claim 1, further comprising updating a thumbnail image of the selected video on the editing board so as to indicate that the selected video has been edited.

5. The method of claim 1, further comprising encoding the edited version of the selected video into a desired format.

6. The method of claim 5, wherein the desired format is a format required by a website, wherein the method further comprises uploading the encoded format to the website.

7. The method of claim 1, wherein the integrated user interface further comprises a plurality of editing command buttons, each configured to generate an editing command.

8. The method of claim 1, wherein editing the selected video comprising at least one selected from the group consisting of cutting the selected video into two or more pieces of videos, combining two or more pieces of cut video pieces, inserting a desired image at a desired point of the selected video, and removing a portion of the selected video.

9. The method of claim 1, wherein editing the selected video further comprising adding a transitional effect to the selected video.

10. The method of claim 1, wherein editing the selected video further comprising adding a special effect to the selected video, wherein the special effect comprises at least one from the group consisting of inserting text and inserting sound at a desired portion of the selected video.

11. The method of claim 1, further comprising, upon completion of editing, uploading the edited version to a website with or without the user's command to upload.

12. The method of claim 1, wherein the selected video further comprises at least one still image.

13. An image editor comprising:
an integrated user interface comprising a preview monitor and an editing board, wherein the editing board comprising a space for displaying thumbnail images of videos;
an image displaying module configure to display a selected video or a still frame thereof on the preview monitor in response to a user's selection of the video and the user's command for playing the selected video; and
an editing module configured to edit the selected video in response to the user's editing command while or after the selected video is played on the preview monitor.

14. The image editor of claim 13, further comprising a decoding module configured to decode a user's selected video in a format playable by the image editor.

15. The image editor of claim 13, wherein the editing module is further configured to update a thumbnail of the selected video on the editing board so as to indicate that the selected video has been edited.

16. The image editor of claim 13, further comprising an encoding module configured to encode the edited version of the selected video in a desired format.

17. The image editor of claim 13, wherein the integrated user interface further comprises a plurality of editing command buttons, each configured to generate an editing command.

18. The image editor of claim 13, wherein the plurality of editing command buttons are configured to initiate an editing action selected from the group consisting of cutting the selected video into two or more pieces of videos, combining two or more pieces of cut video pieces, inserting a desired image at a desired point of the selected video, and removing a portion of the selected video, adding a transitional effect, inserting text, and inserting sound.

19. The image editor of claim 13, further comprising an uploading module configured to upload the edited version to a website without the user's command to upload.

20. A computer executable program for processing a video, wherein when executed the program is configured to have a computer to perform a method comprising:
providing an image editor comprising an integrated user interface, which comprises a preview monitor and an editing board, wherein a plurality of thumbnail images of a plurality of videos are displayed on the editing board;
displaying a selected one of the plurality of videos or a still frame of the selected video on the preview monitor in response to a user's selection of the video and the user's command for playing the selected video; and
editing the selected video so as to provide an edited version of the selected video in response to the user's editing command while or after playing the selected video on the preview monitor.
